(19) United States
(12) Patent Application Publication
(10) Pub. No.: US 2005/0111701 A1
(43) Pub. Date: May 26, 2005

(54) Monitoring system

(75) Inventors: Kenta Seki, Ushiku (JP); Tomoyuki Hamada, Tsuchiura (JP); Takashi Teramoto, Chiyoda (JP)

Correspondence Address: McDermott, Will & Emery, 600. 13th Street, N.W., Washington, DC, 20005-3096, US

(73) Assignee: Hitachi, Ltd.

(21) Appl. No.: 10/878,063

(22) Filed: Jun. 29, 2004

(30) Foreign Application Priority Data
Nov. 26, 2003 (JP) 2003-394871

(51) Int. Cl. H04N 7/18

(52) U.S. Cl. 382/107; 348/143

(57) ABSTRACT

A monitoring system equipped with imaging devices for imaging a monitoring region. Each of the imaging devices has storage device for storing image information. A unique identification number (ID) for identifying a picked-up image is assigned to each of the imaging devices. The picked-up image is retrieved, together with the associated ID, from the storage device by detaching the storage device or accessing the storage device in a non-contact manner.

### INCORPORATION BY REFERENCE

The present application claims priority from Japanese application JP 2003-394871 filed on Nov. 26, 2003, the content of which is hereby incorporated by reference into this application.

### BACKGROUND OF THE INVENTION

The present invention relates to a monitoring system for monitoring security in cities.

JP-A-2002-298260 describes an example of a crime prevention camera system for effecting improvement in the security in cities. According to this publication, a plurality of crime prevention devices each equipped with an emergency alarm including an illumination light, an emergency calling switch, and a crime prevention camera are connected over a network. This arrangement makes it possible to early discover and prevent an incident by a molester or a stalker.

Other example of the crime prevention camera system for securing the security in cities is described in JP-A-2003-109155. The system in this publication monitors a wide range while reducing the labor required for monitoring a monitoring region. Then, at the time of occurrence of a crime, the system receives an alarm from an alarm device operated by a person, performs image processing of a group of time sequential images of the monitoring region, and quickly obtains information about a suspected person.

In the crime prevention system described in the above JP-A-2002-298260 and JP-A-2003-109155, the suspected person is identified using a crime prevention camera, an alarm device, and image processing means, thereby contributing to an initial investigation by the police. The crime prevention camera itself, however, is large, so that an enormous cost for installation is required. Further, since a network connection is necessary for notifying information on actuation of the alarm device and a monitoring device for confirming the situation of an incident is required, the overall system becomes large, so that the costs such as the cost for installation work and the management cost increase.

When the costs increase, the number of crime prevention cameras is limited. Further, the region for monitoring becomes restricted, and blind spots in the monitoring region increase. Further, since the crime prevention camera is connected to the monitoring device, a feeling of discomfort of being always monitored is given to passengers. The crime prevention camera, once installed, is not easy to move, so that the systems of the prior art cannot flexibly accommodate a change in a surrounding environment.

### BRIEF SUMMARY OF THE INVENTION

The present invention has been made in view of disadvantages of the prior arts described above. It is therefore an object of the present invention to construct a monitoring system that takes privacy protection into consideration, easily and at low cost.

The monitoring system according to one aspect of the present invention for achieving the above object includes:
a plurality of imaging means each having a unique identification number, disposed in a monitoring region; and
storage means provided for each of the imaging means, for storing an image picked up by each of the imaging means;
wherein the storage means has a unique identification number storage unit for storing the unique identification number assigned to each of the imaging means.

Preferably, the monitoring system according to the one aspect of the invention further includes image retrieval means for retrieving, in a non-contact manner, the unique identification number and the image stored in the storage means, and image analysis means for analyzing the retrieved image. Preferably, the storage means is detachably provided for each of the imaging means and includes analysis means for analyzing the image stored in the storage means. Preferably, each of the imaging means further includes communication means and the image and the unique identification number stored in one of the imaging means can be transmitted to the other one of the imaging means through the communication means. Preferably, each of the imaging means performs imaging at a predetermined interval, and includes time management means for storing in the storage means time data indicating the time of the imaging, together with the image.

In the monitoring system according to the one aspect of the invention, each of the imaging means may include password number storage means and password number identification means, and it may be so arranged that the image retrieval means can retrieve the unique identification number and the image stored in the storage means only when the password number identification means recognizes that password number information transmitted from the image retrieval means matches password number information stored in the password number storage means in advance. The monitoring system according to the one aspect of the invention may further include image information management means for writing the unique identification number in the detachable storage means. The monitoring system according to the one aspect of the invention may further include a centralized monitoring device provided separately from the imaging means, for receiving the image and the unique identification number transmitted from one of the imaging means to the other one of the imaging means.

In the monitoring system according to the one aspect of the invention, one of the imaging means may transmit the unique identification number thereof and the picked-up image to the other one of the imaging means when a storage capacity of the storage means included in one of the imaging means drops to a predetermined level or less. Each of the imaging means may include abnormality detection means, and may transmit the unique identification number thereof and the picked-up image to the other one of the imaging means when the abnormality detection means of one of the imaging means determines the state of one of the image detection means satisfies a predetermined criterion.

Then, preferably, each of the imaging means further includes power supply means. Preferably, each of the imaging means further includes voice input means, and each of the imaging means starts imaging when a voice at a predetermined volume level or higher is input. Preferably, dummy imaging means having an external shape substantially identical to external shapes of the imaging means is mixed with the imaging means.

In a monitoring system according to another aspect of the invention for monitoring images picked up by a number of imaging means disposed in a monitoring region, the imaging means each having a unique identification number thereof, an image picked up by one of the imaging means is retrieved together with the unique identification number of the imaging means in a non-contact manner. In the monitoring system according to the another aspect of the invention, it may be so arranged that the image can be retrieved only when a password number matching a password number stored in one of the imaging means is input.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a block diagram showing an embodiment of a monitoring camera system according to the present invention;

FIG. 2 is a perspective view of a monitoring system employing the monitoring camera shown in FIG. 1;

FIG. 3 is a schematic diagram showing a communication system used in the monitoring system according to the present invention;

FIG. 4 is a diagram showing image analysis;

FIG. 5 is a top view of a monitoring system according to other embodiment of the present invention; and

FIG. 6 is a top view of a monitoring system according to other embodiment of the present invention.

### DETAILED DESCRIPTION OF THE INVENTION

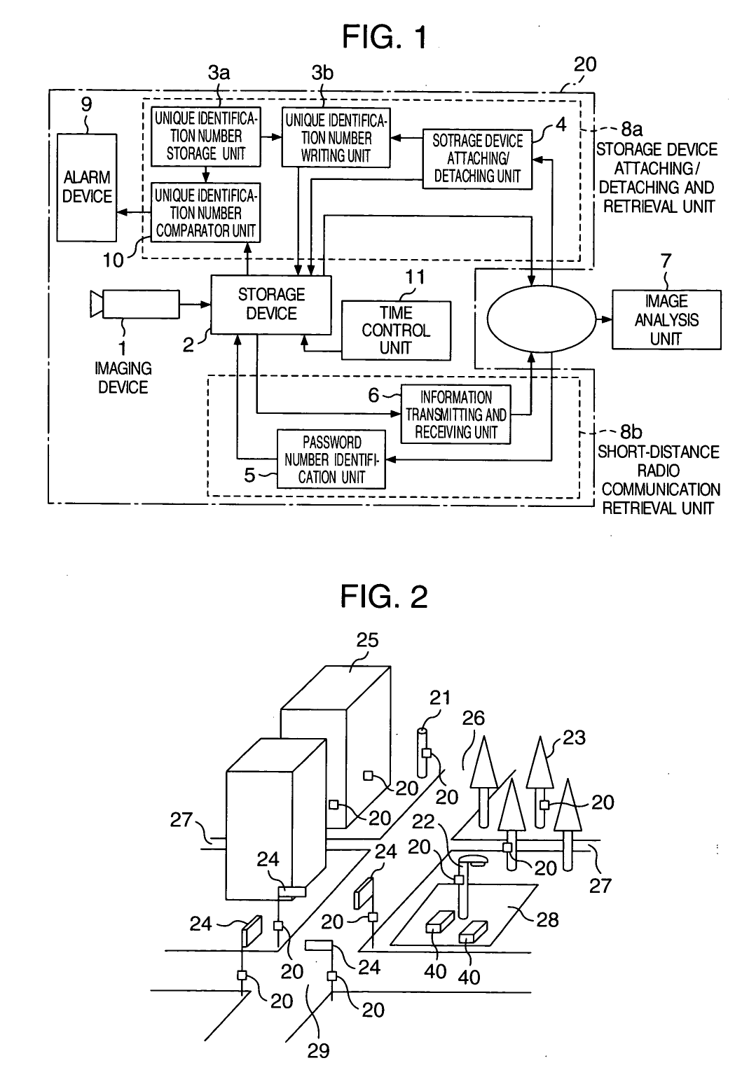

Embodiments of a monitoring system according to the present invention will be described below with reference to FIGS. 1 to 6.

FIG. 1 is a block diagram showing a monitoring camera system, and FIG. 2 shows a perspective view of the monitoring system. Referring to FIG. 2, many monitoring cameras are installed throughout streets targeted for monitoring. A monitoring camera 20 includes an imaging device 1 for imaging a monitoring region and a storage device 2 for storing information on an image picked up by the imaging device 1.

The information on the image picked up by the imaging device 1 is identified using a unique identification number storage unit 3a, a unique identification number writing unit 3b, and a unique identification number comparator unit 10 included in a storage device attaching/detaching and retrieval unit 8a. The storage device attaching/detaching and retrieval unit 8a also includes a storage device attaching/detaching unit 4 for physically retrieving from the monitoring camera 20 the storage device 2 in which the information on the image is stored.

On the other hand, the image information stored in the storage unit can also be retrieved through communication means. A short-distance radio communication retrieval unit 8b is provided in the monitoring camera 20, which includes a password number identification unit 5 and information transmitting and receiving unit 6.

The monitoring camera 20 also includes an alarm device 9 for giving an alarm when an abnormal access has been made to the monitoring camera 20. An image analysis unit 7 is provided, being off line with the monitoring camera 20. The image information stored in the storage device 2 and then retrieved using the storage device attaching/detaching and retrieval unit 8a and the information transmitting and receiving unit 6 is efficiently processed by the image information analysis unit 7.

The imaging device 1 is a small CCD solid-stage image pickup element. In a place with a small light intensity, in which shooting is difficult to do, if an infrared light-receiving element capable of shooting even at night is employed, information on a clearer image can be obtained. The storage device 2 can be such as a small one-inch type hard disk drive or flash memory with a large capacity, and can be attached to or detached from the monitoring camera 20. The information on the picked-up image can record a video of one day or more. A new image is overwritten into an old image successively, for storage.

The image information stored is intermittently stored still images shot at predetermined intervals, not a moving image. These still images are stored with accurate time data provided by a time control unit 11 that has a radio wave clock. The intermittent storage of the still images reduces power consumption of the monitoring camera 20, so that long duration recording becomes possible. In the intermittent storage of the still images, it is not that the images shot at fixed intervals are used for storage as they are but that old images shot in remoter past are subjected to decimation or thinning-out operation for storage, and newer images that were shot lately are stored a greater number. Take, for example, image information shot one day before, every second frame may be stored in order in which they were shot; and for image information shot two days before, only one exposure out of every three frames may be stored. If old images are stored as much as possible in this way, images shot over a long shooting period can be stored. Alternatively, if a voice input device such as a microphone is provided for the monitoring camera 20 so that an image may be stored in the storage device when the voice exceeding a predetermined volume level is input, intermittent recording will be performed, making it possible to realize a shooting in an extended time period.

As a power supply means (not shown) in the monitoring camera 20, a fuel battery or a solar battery, vibration-induced power generator that uses vibration of a magnet mounted on a spring owing to external vibrations, or a driving voltage generating apparatus for generating power from the power line in a non-contact manner using a coil without contact is employed. These power supplies may be combined with a secondary battery. Since a power supply means is provided for each monitoring camera 20, the monitoring camera 20 can operate independently. Wiring works for installation of monitoring cameras 20 therefore can be dispensed with, so that the monitoring cameras 20 can be installed under any environment. If power is derived from the power line near the monitoring camera 20, a faulty operation due to the power supply such as battery exhaustion can be reduced.

An embodiment of the monitoring system having a multiplicity of the monitoring cameras 20 is shown in FIG. 2 which is the perspective view showing installation of the monitoring cameras 20 in FIG. 1 throughout the streets. The monitoring cameras 20 are installed in places such as a utility-line pole 21, a street lamp 22, street trees 23, traffic lights 24, a wall surface of a building 25, a back street 27, and a parking lot 28 with a lot of vehicles with no people 40, irrespective of their height.

The monitoring camera 20 is not connected to a wired communication line including ISDN nor a wireless LAN associated with access points, in view of privacy protection. Further, a monitoring device such as a monitor or a server is not provided, either, for privacy protection. In the monitoring system according to this embodiment, constant monitoring has become unnecessary, so that the installation cost and labor costs can be reduced.

Details of an operation of the monitoring system using the monitoring cameras 20 configured as described above will be described below. A number of the monitoring cameras 20 installed throughout the streets are managed by assignment of unique identification numbers to the respective monitoring cameras 20. The unique identification numbers are registered in electronic map information such as a Geographic Information System (GIS) or the like in advance. Using this information, installation positions of the respective monitoring cameras 20 are kept track of. When image information picked up by the imaging device 1 and then stored in the storage device 2 is retrieved or when the monitoring camera 20 is checked, the unique identification number is referred to. In an investigation about occurrence of an accident such as a traffic accident, which will be described later, the unique identification number of the monitoring camera 20 is referred to, thereby retrieving the image of the location where the accident has occurred.

When retrieving image information from the monitoring camera 20, either of the following two methods are used properly according to readiness of retrieving the information: first is a method in which the storage device 2 is directly taken out from the monitoring camera 20, while second is the method in which only the information stored in the storage device 2 is retrieved through communication means without moving the monitoring camera from its installation place. The first method is employed when the monitoring camera 20 is installed at such a height as can be attached and detached by a person or the number of images to be retrieved is small. In this case, the storage device attaching/detaching and retrieval unit 8a is used for the retrieval.

A button of the storage device attaching/detaching unit 4 is provided on a surface of the monitoring camera 20. When this button is depressed, the storage device 2 is ejected from the monitoring camera 20. This button is locked by a locking mechanism such as a number lock, a card reader, or a pad lock. A plurality (normally two) of releasing devices used when releasing this locking mechanism is prepared and managed by two stations (offices) in the monitoring region. An image information retriever (person) in one organization receives the releasing devices under the consent of the other organization. If the two releasing devices do not match, the locking mechanism cannot be released. The images of the monitoring cameras 20 are managed separately by the two organization, thereby preventing leakage and abuse of information to protect privacy.

The unique identification number writing unit 3b writes a unique identification number that is recorded into the storage device 2 in advance, in the unique identification number storage unit 3a. The unique identification number storage unit 3a includes an EEPROM and is readable and writable. The unique identification number writing unit 3b writes the unique identification number into the storage device 2 when image information is retrieved or the storage device 2 is attached.

The unique identification number comparator unit 10 makes a comparison to see whether the unique identification number has been correctly written or not, and when a wrong unique identification number is written, the alarm device 9 issues an alarm to the image information retriever. The alarm device 9 also issues the alarm when the monitoring camera 20 has been stolen. A vibration sensor not shown is provided in the monitoring camera 20, and in order to guard against the influence of wind, when a vibration having an acceleration at a predetermined level or higher occurs, the alarm is issued.

When it is difficult or bothersome to directly take out the storage device 2 from the monitoring camera 20, the short-distance radio communication retrieval unit 8b is used to retrieve image information alone. This is effective when the monitoring camera 20 is installed in a high place from which the person cannot directly retrieve image information or a large volume of image information is to be retrieved. For retrieval of image information, the image information retriever carries a portable terminal equipped with communication means for retrieving the image information from the monitoring camera 20 by radio communication and a storage unit for recording the retrieved image information.

When the image information retriever has arrived near the target monitoring camera 20 from which the image information is to be retrieved, he transmits the unique identification number of the target monitoring camera 20 to the target monitoring camera 20 through the communication means. The unique identification number comparator unit 10 determines whether the transmitted unique identification number matches the identification number stored in advance in the unique identification number storage unit 3a. When they have matched, the unique identification number storage unit 3a opens the communication port of the monitoring camera 20 and then transmits information inquiring of the retriever his password number.

When the image information retriever transmits two types of password numbers, the password number identification unit 5 in the monitoring camera 20 transmits the image information to the portable terminal if the transmitted password numbers are correct. The information mingled with alphabets and numerics is encrypted so as to be difficult to be intercepted, and is used as the password number for transmission. For transmission of the two types of the password numbers, one image information retriever transmits two types of the password numbers that are authorized to transmit to the image information retriever himself, or two different password numbers are transmitted separately by two image information retrievers.

The information transmitting and receiving unit 6 is short-distance radio communication means for which access points are not required. Communication is performed between a single monitoring camera 20 and a portable terminal for image information retrieval. Alternatively, image information stored in a plurality of the monitoring cameras 20 is conveyed to a single portable terminal, being relayed through the monitoring cameras 20, and is finally transmitted to the portable terminal. On this occasion, the monitoring cameras equipped with a radio communication device temporarily forms a network, so that the information stored in the plurality of monitoring cameras 20 is transmitted over the network. In this direct inter-terminal communication method, the image information stored in the plurality of monitoring cameras 20 can be retrieved at a single retrieval into the portable terminal.

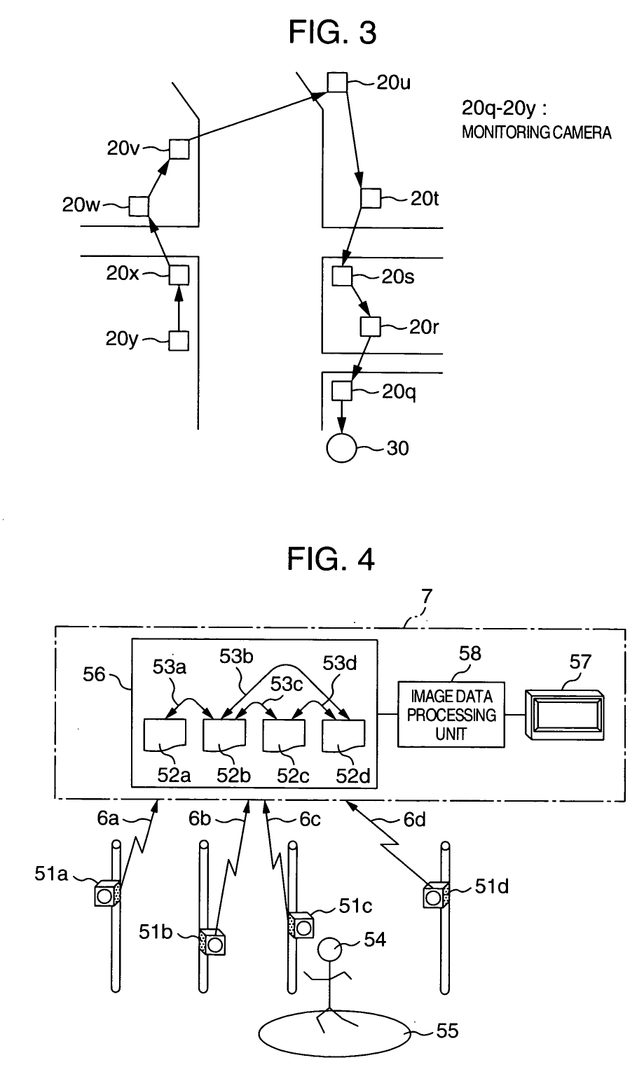

FIG. 3 shows details of the direct inter-terminal communication method. Many monitoring cameras 20q to 20y are installed on streets as shown in FIG. 2. An image information retriever 30 downloads image information in the monitoring camera 20q located at an end of a monitoring region using the portable terminal. When the image information in the monitoring camera 20q is being downloaded, the monitoring camera 20q downloads image information stored in the monitoring camera 20r adjacent to the monitoring camera 20q into the free space of the storage device 2 of the monitoring camera 20q with the unique identification number of the monitoring camera 20r.

Likewise, the adjacent monitoring camera 20r downloads image information stored in the monitoring camera 20s adjacent to the monitoring cameral 20r into the free space of the storage device 2 in the monitoring camera 20r. By repeating this procedure, image information in all the monitoring cameras 20q to 20y in the monitoring region is temporarily stored in the storage device 2 of the monitoring camera 20q. Thus, just by accessing the monitoring camera 20q, the image information retriever can retrieve the information on images shot by all the monitoring cameras 20q to 20y, so that the time required for the retrieval can be saved. As an alternative to retrieval by the image information retriever 30, a centralized monitoring device may be provided in the monitoring region so as to perform unmanned management and retrieval of image information.

When the direct inter-terminal communication method is employed, the presence or absence of an abnormal operation of the monitoring camera can be kept track of, in addition to the retrieval of image information. The electronic map information is stored in the portable terminal, and the unique identification numbers of the monitoring cameras are associated with the electronic map information, for storage in the portable terminal. Determination means for comparing the unique identification numbers transmitted through the monitoring cameras 20q to 20y sequentially with unique identification numbers stored in the portable terminal is provided for the portable terminal. The determination means confirms information in all the monitoring cameras 20q to 20y, and determines the monitoring camera having the untransmitted unique identification number is faulty. The information retriever 30 can instantaneously confirm operation statuses of the monitoring cameras 20q to 20y in the monitoring region from failure information.

Further, when the image information retriever 30 makes the round of the monitoring region using a vehicle, a sensor for detecting the vehicle is mounted on the monitoring camera 20q. Then, if the monitoring camera 20q recognizes the vehicle and the monitoring camera 20q automatically transmits its unique identification number, the time required for the image information retrieval can be reduced. If vehicle detection sensors are mounted on a plurality of monitoring cameras 20, not limited to the monitoring camera 20q alone, image information can be retrieved into the portable terminal with reliability, even if the monitoring camera 20q is defective. Incidentally, means for changing the relaying order of the monitoring cameras 20q to 20y according to the failure of each of the monitoring cameras 20 is provided for the portable terminal.

When the direct inter-terminal communication method is employed, the storage device 2 can be shared by neighboring monitoring cameras. In this case, even if a single storage device in the plurality of monitoring cameras fails, monitoring by the monitoring cameras can be continued. When the direct inter-terminal communication method is employed, abnormality detection means for detecting the abnormality of the storage device 2 is provided for each of the plurality of monitoring cameras. Then, when an abnormality has occurred in one monitoring camera, the abnormality detection means transmits the unique identification number of the defective camera and image information stored in the defective camera to another monitoring camera and shares the storage devices 2 of the another camera. If information on an image is written in the storage device, and then the image is read out immediately after the writing and compared with original image information, an abnormality in the storage device can be readily detected.

Prioritization is performed for sharing of the storage device of the monitoring camera between each of the monitoring cameras and its neighboring monitoring cameras, and the order of priority is registered in each of the monitoring cameras in advance. When an abnormality has occurred in a certain monitoring camera, the monitoring camera with a high priority stores image information shot by itself and image information in the defective monitoring camera in its storage device 2. On this occasion, in order to differentiate between the image information in the two monitoring cameras, the storage region of the storage device 2 is divided using the unique identification numbers assigned to the respective monitoring cameras. Another storage device such as a RAM or another storage region may be provided for each of the monitoring cameras. When image processing of the image shot by the monitoring camera with the high priority is not being performed, only image information transmitted from other monitoring camera is stored in this other storage device.

Depending on the condition under which the monitoring camera is located, the frequency of a change in the image shot by the monitoring camera varies: In some locations, the image frequently changes, while in other locations, the image scarcely changes. As described above, in the location of which the image frequently changes, it is necessary to frequently store image information. On the other hand, in the location of which the image scarcely changes, storage of the image information should be performed only when there was a change in the image, whereby the amount of storage space of the monitoring camera does not need to be large. In such a case, since the storage capacity of the storage device in the monitoring camera that requires a large amount of storage of the image falls short in a short time, the storage device of another monitoring camera that requires only a small amount of storage of the image is used as auxiliary storage means. In this case, as in the time of abnormality occurrence, the storage device can be shared.

For a high-traffic region or the like, a plurality of monitoring cameras are disposed so that a same location can be monitored from different points of view. In this case, in order to save the amount of storage space of each of the monitoring cameras, the timings of shooting by the respective cameras are changed when there is a comparatively small change in the image information. That is, while shooting is performed by one monitoring camera, operations of other monitoring cameras are stopped. This does not interrupt monitoring and can reduce power consumption by the monitoring cameras. Accordingly, frequent retrieval of the storage devices can be avoided.

FIG. 4 shows analysis of retrieved image information using the image information analysis unit 7. A criminal 54 appears in monitoring images 52a to 52d at a certain time obtained by shooting of a monitoring region 55 by a plurality of monitoring cameras 51a to 51d in multiple directions. These monitoring images 52a to 52d are the images which were shot by the monitoring cameras 51a to 51d, respectively, and then transmitted to the image information analysis unit 7 from annexed information transmitting and receiving units 6a to 6d, respectively, through the portable terminal or the like.

The image information analysis unit 7 includes a database 56 of image information, a monitor 57, and an image data processing unit 58. The image data processing unit 58 creates the data base 56 of the image information transmitted from the portable terminal. In order to perform tracking from one image information to other image information with respect to information on the respective monitoring images 52a to 52d of the plurality of monitoring cameras 51a to 51d disposed in the same monitoring region 55, mutual link information 53a to 53d is added to the respective image information. The mutual link information 53a to 53d are respectively determined based on the unique identification numbers of the monitoring cameras 51a to 51d registered in the electronic map information. When an investigator has discovered the criminal in the monitoring image 52b displayed on the monitor 57 by referring to the database 56, by tracking the link information added to the respective images 52a to 52d, the images 52a, 52c, and 52d of the other monitoring cameras 51 for monitoring the same region can be readily referred to.

The frequency of occurrence of crimes such as a random street assault, a snatch, and kidnapping that occur in urban districts is higher in a less-busy back street 27 than in a high-traffic main street 26. Conventionally, in view of the costs and management of a monitoring facility, the monitoring region was restricted to the main street 26 where many people come and go, and the back street 27 was not monitored. For this reason, shooting of the scene of a crime could not be performed, or even if the shooting could be performed, a criminal got away from the monitoring region, so that the image information of the criminal might be lost. Further, since only a small number of monitoring cameras are disposed, the image of the criminal became a wide-angle image or an intermittent image, so that the image becomes unclear, with a low resolution. Thus, it is difficult to identify an individual.

In view of such, in the monitoring system according to the present invention, the monitoring camera 20 is made to have a simple configuration, and is made to be low in cost and easy to install. Accordingly, it becomes possible to use a large number of the monitoring cameras 20. The image angle per monitoring camera 20 can be reduced, so that the resolution of the monitoring camera is improved. Further, since a communication infrastructure is not necessary, the monitoring system that does not depend on the communication infrastructure can be constructed. Thus, the monitoring region can be expanded from the main street to the back street, and exhaustive monitoring can also be performed. The installation position of the monitoring camera 20 can be expanded to a lower position, too, so that feature recognition using a face image becomes easy.

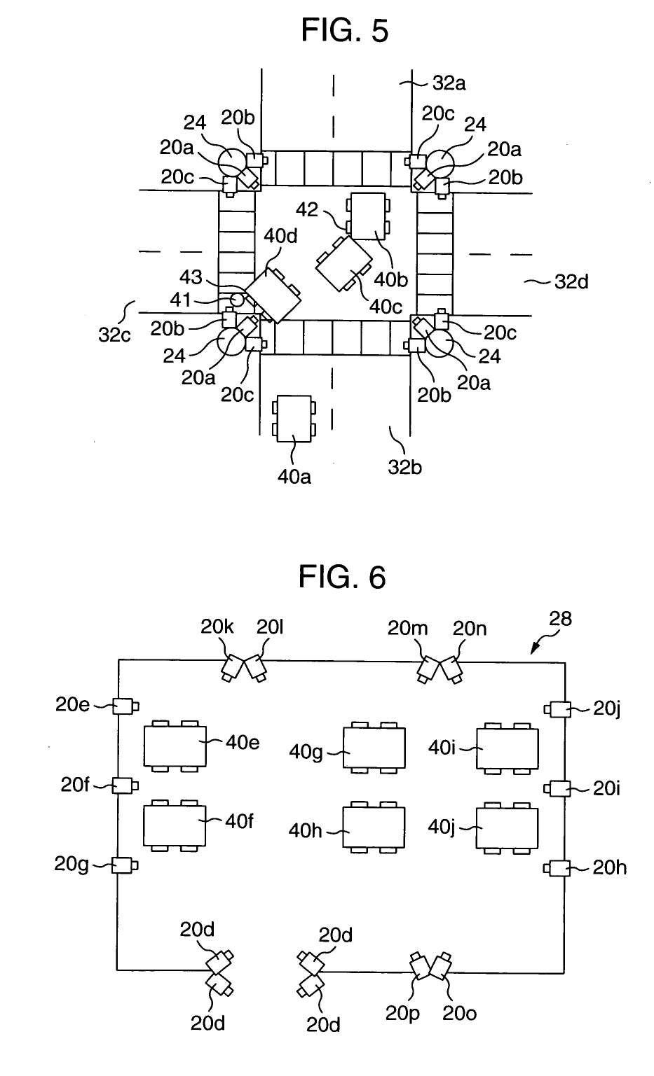

FIG. 5 shows an example in which the installation positions of the monitoring cameras have been changed from the urban district to an intersection, while FIG. 6 shows an example in which the installation positions of the monitoring cameras have been changed to a parking lot 28. FIG. 5 is a top view showing a number of the monitoring cameras 20, one of which was shown in FIG. 1, at an intersection 29. At four corners of the intersection 29, monitoring cameras 20a facing the center of the intersection and monitoring cameras 20b and 20c disposed on both sides of each of the monitoring cameras 20a and facing in directions that cross respective roads 32a to 32d are provided.

FIG. 5 shows an accident 42 in which a vehicle 40b driven straight forward on a road 32a collided with a vehicle 40c that turned right on an opposed road 32b and an accident 43 in which a vehicle 40d that turned left has hit a pedestrian 41. Since the accident inside the intersection is monitored by the monitoring cameras 20a that face the center of the intersection and the accident on the pedestrian crossover is monitored by the monitoring cameras 20b and 20c, the state of the accidents can be captured from different points of view. The situation before and after the accidents can be thereby tracked properly.

FIG. 6 is a top view of the parking lot 28. Monitoring cameras 20d are disposed near the gateway of the parking lot. Monitoring cameras 20e to 20j are disposed at the edges of the wall of the parking lot 28 so as to monitor regions between vehicles. Monitoring cameras 20k to 20p are disposed at the edges of the walls of the parking lot 28 so as to monitor from remote locations the roads in the parking lots and regions between the vehicles. Since the monitoring cameras are disposed as in the above-mentioned way, the monitoring camera 20d can capture access of a suspicious individual to the parking lot 28. Even if an incident has occurred between parking vehicles 40e and 40f, the monitoring cameras 20f and 20k are shooting the accident from different directions, so that the features of the criminal of the incident can be readily captured.

As described above in detail, the embodiments described above reduce labor for the operation of image confirmation and also serve as an aid in the early arrest of criminals. Further, in a traffic accident that has occurred at an intersection, by combining images of the scene of the accident shot in multiple directions and displaying the images in time sequence, movements of associated vehicles and passers-by can be associated with the statuses of traffic lights around the scene of the accident, so that the condition of the accident at that time can be three dimensionally reproduced. As a result, a victim and a perpetrator can be readily identified.

If the image analysis unit 7 refers to time information recorded simultaneously when image information is recorded and extracts only image information before and after an incident, the time required for image analysis can be reduced. Further, if synchronization with the time information is performed, a monitoring status can be reproduced in a versatile manner when a plurality of image information is displayed on a single monitor. If an atomic clock is included in the monitoring camera, the time information is recorded more accurately, and the times or clocks of a plurality of monitoring cameras can be readily and automatically synchronized with each other.

If the image analysis unit 7 extracts image information of a suspicious person using face image recognition software or the like, he can be tracked using information on the features of a criminal obtained by legwork around the crime by the criminal or the like. On this occasion, if image information of an identical location shot in multiple directions is combined to create a three-dimensional image, the physical features of the criminal are easy to capture. If software for detecting registered numbers of vehicles is used, quick detection and tracking of a stolen car at the time of a crime or a car used in an accident can be performed. By using the image analysis unit in this way, collective analysis of obtained abundant image information can be performed, so that labor cost and labor associated with an investigation can be reduced. Further, the investigation is sped up.

Incidentally, if the monitoring system in the above embodiment is additionally introduced into an environment having an existing monitoring system, blind spots of the existent monitoring system can be decreased, and the network of existent facilities can also be used.

There is provided a variation of the monitoring system of the present invention in which the monitoring camera 20 is made to be transportable. In the conventional monitoring system using monitoring cameras, the monitoring cameras were installed in fixed positions, so that they could not be readily moved. This variation, however, can flexibly handle a change in a surrounding environment. It means that, since connection of the monitoring camera to the network is not necessary and monitoring by the monitor is not required, latitude in installation of the monitoring camera is high. The monitoring camera can be temporarily installed in a needed place when necessary. In an intersection example in FIG. 3, for example, in addition to monitoring cameras installed permanently, some monitoring cameras are temporarily installed and are used for measuring the traffic amount.

The system using the monitoring cameras shown in the above embodiments can be utilized for a human flow study in areas around train stations and shopping districts with many people coming and going and gathering of customer marketing information in places such as department stores and super markets. If image information processing means for performing face image recognition and vehicle registration number detection is utilized, labor required for the study can be reduced. Further, since necessary information can be automatically retrieved without making confirmation through the monitor, privacy invasion can be suppressed to a minimum. The monitoring system of the present invention can also be used as a temporary monitoring system for the time period and the place of an event such as a festival or a concert, in which people's comings and goings are temporarily concentrated.

Further, if a dummy monitoring camera having an identical external shape is included in the monitoring cameras 20 installed in urban areas or the like, a burglar can be disturbed or can be made to decrease his willingness to commit burglary.

According to the present invention, since the monitoring cameras of a simple configuration are respectively installed on a standalone basis, the monitoring cameras can be installed in a large volume, so that monitoring blind spots can be reduced. Further, since networking and permanent monitoring are avoided, a feeling of discomfort due to privacy invasion can be reduced. These arrangements improve security in cities. The above embodiments and variation are only exemplary, and are not intended to impose limitations on the invention. The scope of the present invention is set forth in appended claims.

1. A monitoring system comprising:
a plurality of imaging means each having a unique identification number, disposed in a monitoring region; and
storage means provided for each of the imaging means, for storing an image picked up by said each of the imaging means;
wherein the storage means has a unique identification number storage unit for storing the unique identification number assigned to said each of the imaging means.

2. The monitoring system according to claim 1, further comprising:
image retrieval means for retrieving, in a non-contact manner, the unique identification number and the image stored in the storage means; and
image analysis means for analyzing the retrieved image.

3. The monitoring system according to claim 1, wherein the storage means is detachably provided for said each of the imaging means and includes analysis means for analyzing the image stored in the storage means.

4. The monitoring system according to claim 1, wherein said each of the imaging means further comprises communication means and the image and the unique identification number stored in one of the imaging means can be transmitted to another of the imaging means through the communication means.

5. The monitoring system according to claim 1, wherein said each of the imaging means performs imaging at a predetermined interval, and includes time management means for storing in the storage means time data indicating a time of the imaging, together with the image.

6. The monitoring system according to claim 2, wherein said each of the imaging means includes password number storage means and password number identification means, and the image retrieval means can retrieve the unique identification number and the image stored in the storage means only when the password number identification means recognizes that password number information transmitted from the image retrieval means matches password number information stored in the password number storage means in advance.

7. The monitoring system according to claim 3, further comprising:
image information management means for writing the unique identification number in the detachable storage means.

8. The monitoring system according to claim 4, further comprising:
a centralized monitoring device provided separately from said each of the imaging means, for receiving the image and the unique identification number transmitted from said one of the imaging means to said other one of the imaging means.

9. The monitoring system according to claim 4, wherein said one of the imaging means transmits the unique identification number thereof and the picked-up image to the other one of the imaging means when a storage capacity of the storage means included in said one of the imaging means drops to a predetermined level or less.

10. The monitoring system according to claim 4, wherein said each of the imaging means further comprises abnormality detection means, and said one of the imaging means transmits the unique identification number thereof and the picked-up image to said other one of the imaging means when the abnormality detection means of said one of the imaging means determines a state of said one of the image detection means satisfies a predetermined criterion.

11. The monitoring system according to claim 1, wherein said each of the imaging means further comprises power supply means.

12. The monitoring system according to claim 1, wherein said each of the imaging means further comprises voice input means, and said each of the imaging means starts imaging when a voice at a predetermined volume level or higher is input.

13. The monitoring system according to claim 1, wherein dummy imaging means having an external shape substantially identical to external shapes of the imaging means is mixed with the imaging means.

14. A monitoring system for monitoring images picked up by a plurality of imaging means disposed in a monitoring region, the imaging means each having a unique identification number thereof, wherein one of the images picked up by one of the imaging means is retrieved together with the unique identification number of said one of the imaging means in a non-contact manner.

15. The monitoring system according to claim 14, wherein said one of the images can be retrieved only when a password number matching a password number stored in said one of the imaging means is input.

16. The monitoring system according to claim 2, wherein said each of the imaging means further comprises power supply means.

17. The monitoring system according to claim 3, wherein said each of the imaging means further comprises power supply means.

18. The monitoring system according to claim 4, wherein said each of the imaging means further comprises power supply means.

19. A monitoring system comprising:
a plurality of imaging devices each having a unique identification number, disposed in a monitoring region; and
a storage device provided for each of the imaging devices, which stores an image picked up by said each of the imaging devices;
wherein the storage device has a unique identification number storage unit for storing the unique identification number assigned to said each of the imaging devices.

20. The monitoring system according to claim 19, further comprising:
an image retrieval unit which retrieves, in a non-contact manner, the unique identification number and the image stored in the storage device; and
an image analysis unit which analizes the retrieved image.

21. The monitoring system according to claim 19, wherein the storage device is detachably provided for said each of the imaging devices and includes an analysis unit which analyzes the image stored in the storage device.

22. The monitoring system according to claim 19, wherein said each of the imaging devices further comprises a communication unit and the image and the unique identification number stored in one of the imaging devices can be transmitted to another of the imaging devices through the communication unit.

23. The monitoring system according to claim 19, wherein said each of the imaging devices performs imaging at a predetermined interval, and includes a time management unit which stores in the storage unit time data indicating a time of the imaging, together with the image.

24. The monitoring system according to claim 19, wherein said each of the imaging devices further comprises a power supply unit.

25. The monitoring system according to claim 19, wherein said each of the imaging devices further comprises a voice input unit, and said each of the imaging devices starts imaging when a voice at a predetermined volume level or higher is input.

26. The monitoring system according to claim 19, wherein a dummy imaging device having an external shape substantially identical to external shapes of the imaging devices is mixed with the imaging devices.
